(19) United States
(12) Patent Application Publication
(10) Pub. No.: US 2008/0077535 A1
(43) Pub. Date: Mar. 27, 2008

(54) System and Method for Facilitating Media Creation

(76) Inventor: Brandt M. Cannici, Arlington, TX (US)

Correspondence Address: SCOTT T. GRIGGS, 901 MAIN STREET, SUITE 6300, DALLAS, TX, 75202, US

(21) Appl. No.: 11/857,631

(22) Filed: Sep. 19, 2007

Related U.S. Application Data
(60) Provisional application No. 60/826,734, filed on Sep. 22, 2006.

(51) Int. Cl. G06Q 10/00

(52) U.S. Cl. 705/80

(57) ABSTRACT

A system and method for facilitating media creation is disclosed that includes a marketplace module and facilitator that enable an artist to create a work or media and then distribute the work or media to the public, or a segment thereof. The marketplace module provides avenues for free speech, commentary, and constructive criticism, for example, of an artist's idea or work in order to encourage the creation of media which appeals to a minimum threshold of the public. The facilitator aggregates funds to satisfy an artist's commission by enabling negotiations between one or more members of the public and the artist.

### PRIORITY STATEMENT & CROSS-REFERENCE TO RELATED APPLICATIONS

This application claims priority from co-pending U.S. Patent Application No. 60/826,734, entitled “System and Method for Facilitating Media Creation and Distribution” and filed on Sep. 22, 2006, in the name of Brandt M. Cannici; which is hereby incorporated by reference for all purposes.

### TECHNICAL FIELD OF THE INVENTION

This invention relates, in general, to the creation and distribution of media and, in particular, to a system and method for facilitating media creation by bringing together consumers and artists via a networked environment such as the Internet.

### BACKGROUND OF THE INVENTION

Without limiting the scope of the present invention, its background will be described with reference to the digital media industry, as an example. The digital media industry and other digital media owners that distribute digital media have implemented business models that rely on their ability to collect a fee from consumers for each copy or use of a digital work. Presently, once initial distribution of the media has occurred, the unauthorized reproduction or piracy by consumers of the digital media, which is often protected by copyright, constitutes a threat to the viability and profitability of the digital media industry.

With the advent of peer-to-peer file sharing technology, there is no longer any cost associated with the copying and distribution of digital media, since consumers now perform these functions themselves. Attempts to stop the copying and distribution of digital content have proven ineffective. Litigation has failed to mitigate the copying and distribution of digital content due to the large number of offenders, technology that enables offenders to remain anonymous, and the damaging effect of litigation on the brand name. Similarly, Digital Rights Management (DRM), or digital restriction management, as it is less frequently called, technology that manages and enforces particular controls and restrictions associated with the use of digital media has proven ineffective as it disrupts the user experience and can be easily circumvented. Accordingly, a need exists for systems and methods that provide and ensure value in media creation in a peer-to-peer file sharing environment.

### SUMMARY OF THE INVENTION

A system and method for facilitating media creation is disclosed that provides for the creation of media within a networked environment having peer-to-peer file sharing or equivalent technology. Rather than restricting the distribution of media within a peer-to-peer file sharing environment, the system and method presented herein provide a source of value in the media creation.

In one implementation, the system and method include a social network that utilizes a distributed computer network, such as the Internet, to interconnect the public and artists (or authors or other creative individuals). The system and method provide an integrated marketplace module and facilitator that enable an artist to create a work or media and then distribute the work or media to the public, or a segment thereof. The marketplace module provides the public avenues for free speech, commentary, and constructive criticism, for example, of an artist's idea or work in order to encourage the creation of media which appeals to a minimum threshold of the public. The facilitator aggregates public funds, including uniform and non-uniform contributions from consumers, to satisfy an artist's commission by enabling negotiations between one or more members of the public and the artist. These collective negotiations or collective bargaining services allow consumers to pledge varying amounts of money or non-uniform amounts of money to the artist's commission. The bargaining services provided by the systems and methods presented herein define a plurality of stages and then progressively limit the rights of the one or more consumers and the artist as the bargaining progresses through the plurality of stages.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a functional block diagram of one embodiment of a system for facilitating the creation of media;

FIG. 2A is a schematic block diagram depicting in further detail the system for facilitating the creation of media depicted in FIG. 1;

FIG. 2B is an operational schematic block diagram depicting in further conceptual detail the system for facilitating the creation of media depicted in FIG. 1;

FIG. 3 is a schematic block diagram of one further detailed embodiment of the system of FIG. 2A wherein artists and consumers are exchanging requests and proposals about the creation of media;

FIG. 4A is a schematic block diagram of one further detailed embodiment of the system of FIG. 2A wherein artists and consumers are negotiating the creation of an instance of media;

FIG. 4B is a schematic block diagram of one further detailed embodiment of the system of FIG. 2A wherein an artist and a group of consumers have reached an agreement over the creation of an instance of media;

FIG. 5 is a schematic block diagram of one further detailed embodiment of the system of FIG. 2A wherein the artist is creating the commissioned instance of media;

FIG. 6 is a schematic block diagram of one further detailed embodiment of the system of FIG. 2A wherein the instance of media is being reviewed and distributed;

FIG. 7A is a flow chart depicting one embodiment of a method for facilitating the creation of media;

FIG. 7B is a flow chart depicting a further embodiment of a method for facilitating the creation of media;

FIG. 8A is a time line depicting one embodiment of the stages a consumer encounters during the creation of the media;

FIG. 8B is a time line depicting one embodiment of the stages an artist encounters during the creation of the media;

FIG. 8C is a time line depicting one embodiment of the stages a critic encounters during the creation of the media;

FIG. 8D is a time line depicting one embodiment of the stages the industry encounters during the creation of the media;

FIG. 9 is a flow chart depicting another embodiment of a method for facilitating media creation; and

FIG. 10 is a flow chart depicting a further embodiment of a method for facilitating media creation.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

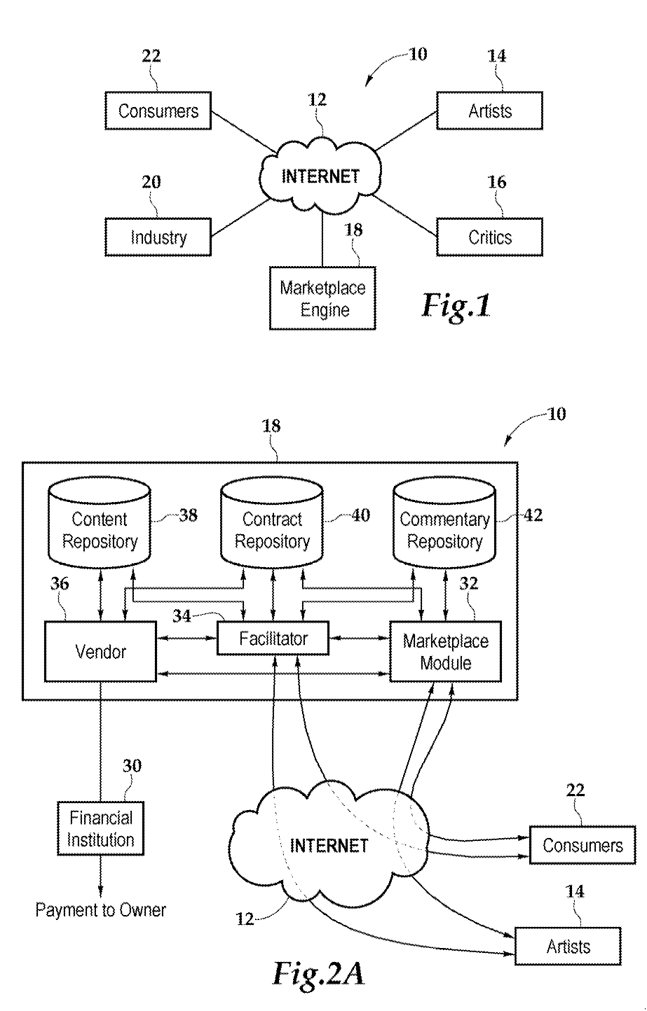

Referring initially to FIG. 1, therein is depicted a system 10 in a networked environment for facilitating media creation via a computer network that is illustrated as Internet 12. As shown, the networked environment interconnects artists 14, critics 16, a marketplace engine 18, the industry 20, and consumers 22. The artists 14 use imagination, and talent or skill in activities such as drawing, painting, writing, film making, photography, and music to create media that can be judged to have an aesthetic value. Moreover, as used herein, the artists 14 include individuals of any vocation or occupation offering any type of media, which is intended to include any type of publication or document or knowledge that may be recorded digitally, affixed to or expressed in a medium, or redacted to print, for example. Artists may include scientists, engineers, and architects, for example, creating or developing formulas or DNA sequences, infrastructure and roadway plans, and urban streetscape designs, for example.

The critics 16 offer reasoned judgement or analysis of the media created by the artists 14. The industry 20 consists of a large number of sub-industries devoted to the aforementioned pursuits of the artists. Typically, the industry 20 has an ownership interest in the media or similar media that is produced. It should be appreciated, however, that in certain instances, all ownership interest may vest in the artists 14. Consumers 22 are individuals or other types of entities that purchase and/or obtain the media created by the artists 14.

The marketplace engine 18 of the present invention provides an environment for consumers 22 to aggregate funds and negotiate with artists 14, or one of the artists, to create an instance of media. More particularly, in one embodiment, the marketplace engine 18 accepts a request from a consumer that specifies characteristics of an instance of media. An artist or artists submit a proposal in response to the request which describes terms of creation of the instance of media. This proposal may also include characteristics of the instance of media. Consumers 22 are able to tie pledges of money to the proposals through the marketplace engine 18 and an artist may provide feedback received from the consumers 22. As the process progresses, the proposal and then the pledges of money are firmed and the artist is presented with the opportunity to accept the pledges of money in return for creating the instance of media. At this time, the marketplace engine 18 commissions the instance of media.

Throughout the process, the critics 16 preferably offer valid and well-reasoned opinions about the work and media of the artists 14 with the intention of helping the consumers 22 and/or the artists 14, rather than creating a negative atmosphere. Once the instance of media is commissioned and prior to its dissemination or release, the marketplace engine 18 may present the industry 20 with an opportunity to review the media and express any concerns about the intentional or unintentional misappropriation or infringement of any intellectual property rights of the industry. The industry 20 may use any one of a variety of methods to review the media created by the artist from an audio or visual inspection to computer assistance using heuristics or expert systems, for example, or any combination thereof.

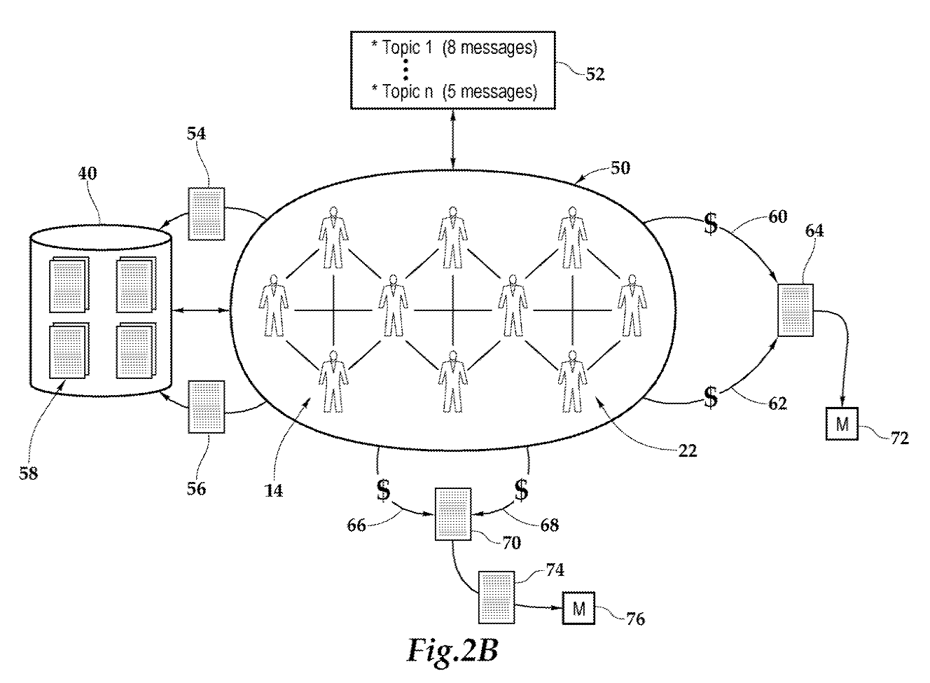

FIG. 2A depicts the system 10 for facilitating the creation of media originally presented in FIG. 1. As previously discussed, the Internet 12 connects the marketplace engine 18, the artists 14, and the consumers 22 in any type of network deployment and file distribution protocol, whether, for example, server-based, peer-to-peer based (by way of further example, using BitTorrent protocol), or a combination thereof. The Internet 12 may also connect the marketplace engine 18 to a financial institution 30 which in some embodiments may provide trust or escrow and transaction services. As illustrated, however, the marketplace engine 18 and the financial institution 30 are connected by an alternative system. Other components of the illustrated system may be connected via alternative connections as well.

The marketplace engine 18 may comprise any combination of hardware, software, and firmware. Similarly, the consumers 22 and artists 14 (as well as critics 16 and industry 20, which are not illustrated) may be utilizing any combination of hardware, software, and firmware to connect to the marketplace engine 18. With respect to the marketplace engine 18, more specially, the marketplace engine 18 includes a marketplace module 32, a facilitator 34, a vendor 36, a content repository 38, a contract repository 40, and a commentary repository 42; all of which may be interconnected in any manner.

The marketplace module 32, which may act as a social networking module in some embodiments, is a module that embodies the hardware, software and firmware necessary to connect the artists 14, consumers 22, critics 16, and industry 20 in a social network defining a range of social and professional familiarities therebetween. The social network aspect may include public and private groups and other known restriction and interaction functionalities. Also, socially responsible utilities which age restrict or otherwise restrict content may be included. Further, the marketplace module 32 assists the artists 14, consumers 22, and critics 16 in creating, editing, storing, deleting, identifying, locating, and accessing specifications, whether requests from consumers or proposals from artists, that define proposed terms for creating an instance of media.

The facilitator 34 is a module that embodies the hardware, software and firmware necessary to enable possibly disparate consumers having uniform or non-uniform contributions to aggregate funds and collectively negotiate or bargain with an artist for the mutual objective of creating an instance of media. The vendor 36 includes electronic business applications that facilitate commercial transactions by marketing, selling, and servicing, for example, the media over electronic systems, such as the Internet 12, and other computer networks. Further, the vendor 36 may contain the aforementioned applications that permit the industry 20 to review the media for ownership and intellectual property concerns. It should be appreciated that the marketplace module 32, facilitator 34, and the vendor 36 may be partially or completely integrated in any combination.

The marketplace module 32, facilitator 34, and the vender 36 are supported by the three databases; namely, the content repository 38, the contract repository 40, and the commentary repository 42, which may be partially or completely integrated or include multiple databases or redundant instances. Moreover, each of these components may be distributed over a network or co-located with other components.

The content repository 38 may store the instances of media that are created. The contract repository 40 may store the requests, proposals, contracts, and data necessary to the creation of the contracts and the commissioning of the media. The commentary repository 42 may store the data associated with the social networking functionality of the marketplace engine 18 as well as any commentary, critiques, and criticisms of media as well as of or by the consumers 22, artists 14, critics 16, and the industry 20. It should be appreciated that although a particular set of interconnections are displayed between the marketplace module 32, the facilitator 34, the vendor 36, the content repository 38, the contract repository 40, and the commentary repository 42, other interconnection architectures are within the teachings disclosed herein.

Referring now to FIG. 2B, in operation, the marketplace engine 18 creates a marketplace and social networking space 50 that interconnects both the consumers 22 and the artists 14 in order to facilitate the sharing of information and transactions therebetween. The consumers 22 and the artists 14 communicate through messages, message boards, and other electronic-based forums for exchanging information between interested parties, as represented by message board 52, which is preferably associated with commentary repository 42. Additionally, the consumers 22 and the artists 14 initiate requests, such as request 54, and proposals, such as proposal 56, respectively. As previously discussed, the requests and proposals enable an exchange of specifications that describe the instance of the media that either a consumer wants created or an artist is willing to create. Moreover, the specifications may include descriptions of the desired licensing, control, and distribution policies associated with the media. By way of example, the consumer specifies the general idea of the desired media, the deadline by which any proposals must be submitted, and a list of details that the consumer wants to see in the proposals. Each request is an offer by a consumer to pay an artist in return for the creation and distribution of an instance of media. The proposals may therefore be made in response to a request or, alternatively, a proposal may be initiated by an artist spontaneously and without reference to a particular request or requests.

The consumers 22 and the artists 14 search the contract repository 40 for various requests and proposals, which are generally indicated by the number 58. The social networking space 50 and indexable and searchable contract repository 40 connect groups of the consumers 22 with the artists 14 such that the consumers 22 are able to aggregate funds so that artist created media may be commissioned and exchanged for money or other fungible item. In particular, the consumers 22 may pledge money, which will be held in an escrow account, possibly with assistance of the financial institution 30, to active requests or proposals, until the commissioned media is created. The consumers 22 may associate and pledge non-uniform amounts of money to requests and proposals, respectively. The amount any one consumer may pledge may correspond to the interest possessed by the consumer in the request or proposal as well as the consumers financial wherewithal.

By way of example, the consumers 22 are aggregating funds, as represented by numerals 60, 62, for a proposal 64. Alternatively, the consumers 22 are aggregating funds, as represented by numerals 66, 68, to a request 70. In implementations where the consumers 22 aggregate funds to a proposal 64, the artist is encouraged to create the media 72 in exchange for the pledged money 60, 62. In other implementations where money 66, 68 is pledged to a request, the artists 14 are encouraged to create an associated proposal 74 and, ultimately, media 76 which meets the specifications of the request 70. Further, in particular embodiments where pledges are tied to requests, such as request 70, the artists 14 may be encouraged to bid and compete against each other on a request having significant pledges tied thereto. For example, if x dollars are tied to a request, then the artist having the lowest bid under x dollars would receive the commission. As a further alternative in this implementation, multiple artists 14 could compete for the pledges by each creating media and the consumers 22 voting on which media best fulfills the request 70 and is awarded the pledges.

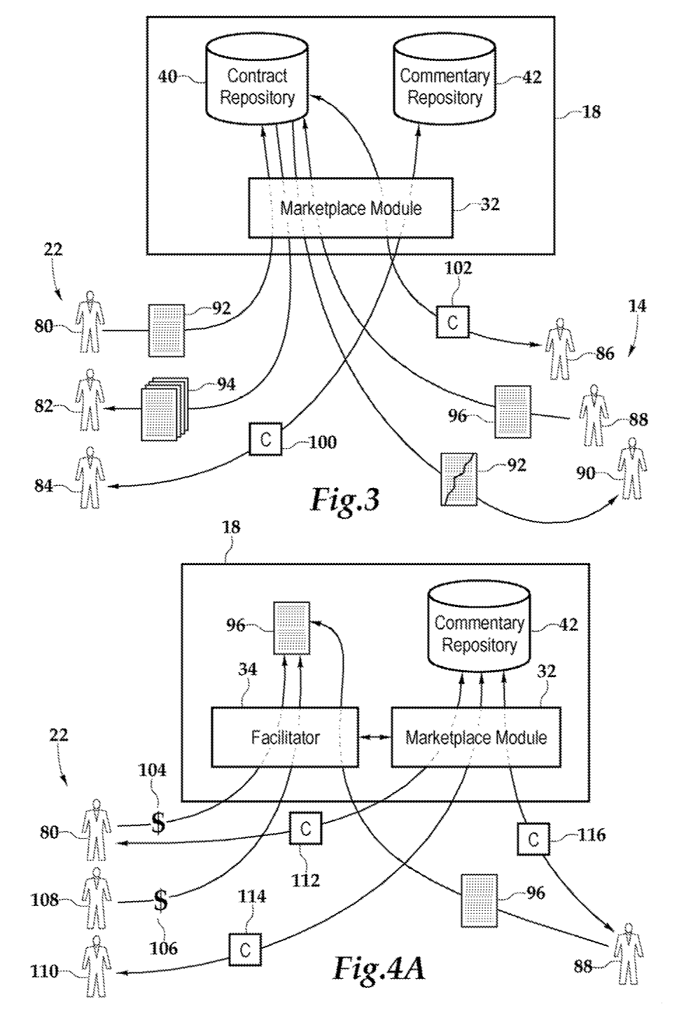

FIG. 3 depicts one further detailed embodiment of the system of FIG. 2A wherein the artists 14 and the consumers 22 are exchanging requests and proposals about the creation of media. The consumers 22 include consumers 80, 82, 84 and the artists 14 include artists 86, 88, 90. Both groups, the consumers 22 and the artists 14, are interfacing with the marketplace engine 18 and, specifically, the marketplace module 32, the contract repository 40, and the commentary repository 42, in the exchange of information. Consumer 80 has uploaded or submitted a request 92 to the contract repository 40 that provides a specification that describes an instance of media that the consumer would participate in a commissioning thereof with funding by way of a pledge. The amount of detail in the specification may vary and may or may not be required to satisfy a minimum threshold of detail. By way of example, a consumer may request a song and define certain characteristics of the song such as genre, verse, chorus, instrumental accompaniment, length and style, for example. By way of another example, the media may be a limited run print or painting and the consumer may define the medium or mediums, size, colors, theme, and other aesthetic characteristics of the work of art, for example.

Continuing with the description of FIG. 3, the consumer 82 is searching for particular requests and multiple proposals 94 stored within the contract repository 40. As illustrated, the consumer 82 is reviewing the request and multiple proposals 94 associated with the request. Each of the proposals was created by an artist in response to reviewing the request. For example, the artist 88 is uploading or submitting a proposal 96 after reviewing the contract repository and finding the request 92 which inspired or otherwise motivated the artist 88. It should be understood that the artist 88 may an individual or a group, whether a band working on a song or group of scientists working on a formulation. On the other hand, It should be appreciated that the artist 90 may have withdrawn a proposal as a result of little interest in the marketplace. Throughout the process, the consumers 22 and the artists 14 may provide commentary about the requests, proposals, and each other, for example. This is depicted by the consumer 84 uploading and downloading commentary 100 to and from the commentary repository 42. Similarly, the artist 86 is engaged in commentary 102. Accordingly, the systems and methods disclosed herein connect multiple consumers with an artist such that a common interest in the creation of an instance of media may be fulfilled.

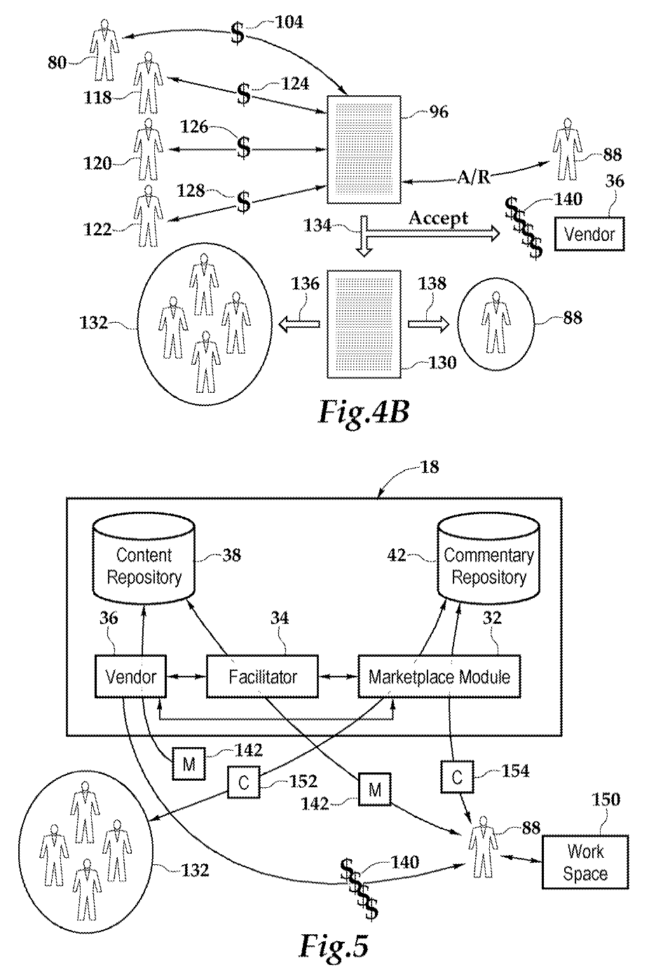

FIG. 4A depicts one further detailed embodiment of the system 10 of FIG. 2A wherein the artists 14 and the consumers 22 are continuing to negotiate the creation of media utilizing the facilitator 34 and marketplace module 32 as well as the commentary repository 42. After the consumer 80 communicated the request 92 to the marketplace engine 18 and the artist 88 communicated a corresponding proposal 96 to the marketplace engine 18, FIG. 4 illustrates a plurality of pledges 104, 106 being associated with the proposal, which is stored in the contract repository 40. As shown, the consumer 80 pledges money to the proposal 96 as represented by the numbered “$” sign and, similarly, another consumer 108 also pledges money 106. In one implementation, the amount of money each consumer 80, 108 pledges may be different. The consumers 22 may pledge money, increase a pledge, decrease a pledge or withdraw a pledge at this time. Additionally, the consumers 22 and the artists 14, including the artist 88, may provide commentary during this time as consumers 80, 110 are providing commentary 112, 114 and the artist 88 is engaged in commentary 116.

FIG. 4B depicts one further detailed embodiment of the system of FIG. 2A wherein an artist and a group of consumers have reached an agreement over the creation of an instance of media. It should be appreciated that during the request and pledge portion of the negotiation process, the consumers 22 or portions of the consumers 22 that have pledged money may dynamically change during the facilitation and agreement of the terms of commission. By way of example, the consumers 80, 118, 120, 122 have pledged money 104, 124, 126, 128, respectively.

As depicted, a number of the consumers 22 have tied pledges to the proposal 96 of the artist 88, at which point the artist 88 may choose to accept or reject the commission 130. As illustrated, the artist 88 accepts the pledges 104 and 126-128, of a group 132 of the consumers 22, i.e., consumers 80 and 118-122, such that a collective agreement is formed, as illustrated by arrow 134, for the proposed instance of media described in the proposal 96. The commission 130, which, in part, includes the pledged money 104, 124, 126, 128, is therefore created between the group 132 of the consumers 22 and the artist 88 as depicted by arrows 136 and 138. Moreover, as indicated by arrow 134, the pledges 104 and 124-128, collectively referred to as pledges 140 are held in trust by the vendor 36 of the marketplace engine 18.

FIG. 5 depicts one further detailed embodiment of the system of FIG. 2A wherein the artist 88 is creating the commissioned instance of media in an artist's work space 150, which may be disconnected and separated from the marketplace engine 18. Once the artist 88 has created the instance of media 142, the artist 88 transfers the media 142 to the content repository 38 where the vendor 36 distributes the media to the group of consumers 132. Additionally, the marketplace engine 18 has been holding the pledges 140 in trust. At this time, in one implementation, the vendor 36 delivers the pledged money 140 to the artist 88 which was held in trust pending a contingency or the fulfillment of the commission 130 and completion of the media 142. Prior to the and after the distribution of the media 142, the group of consumers 132 and the artist 88 may continue to engage in commentary as depicted by commentary 152 and 154.

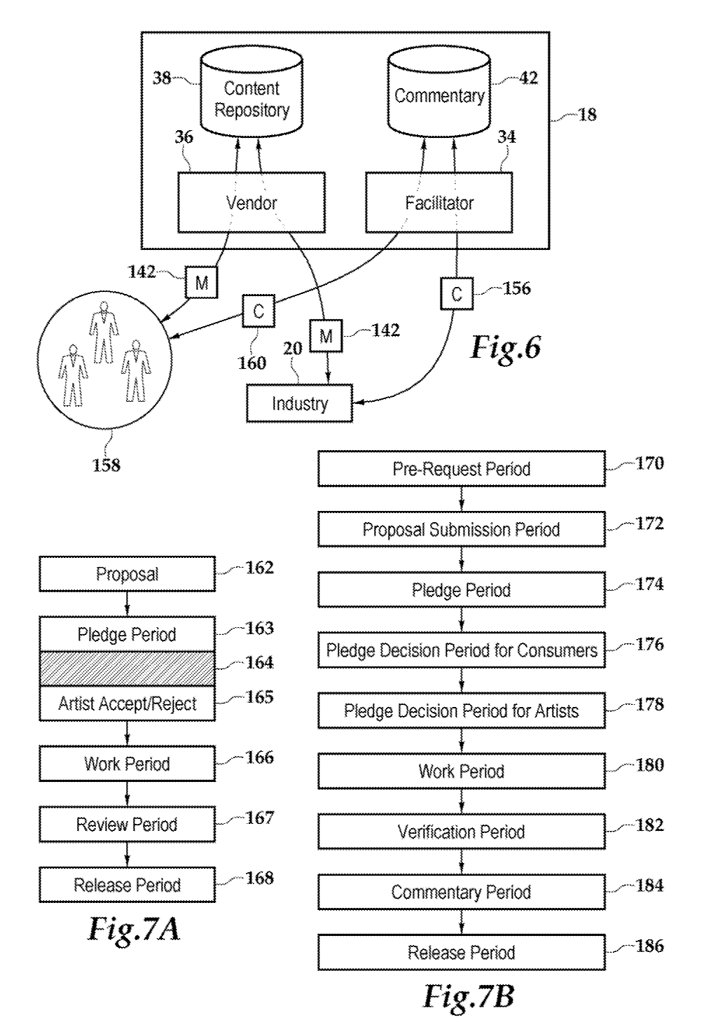

FIG. 6 depicts one further detailed embodiment of the system of FIG. 2A wherein the instance of media 142 is being distributed. As part of the distribution of the media 142, and prior to, concurrently with, or after the distribution of the pledges 140 to the artist, the industry 20 may be provided with an opportunity to review the media 142 and ensure that no misappropriation of intellectual property or copyright protections has occurred. The industry may provide their commentary 156 to the marketplace engine 18 and assuming no misappropriation or concerns, the media 142 may be mass distributed, or otherwise distributed according to the terms of the commission, to the public 158 for the public 158 to enjoy and provide commentary 160.

FIG. 7A depicts a flow chart depicting one embodiment of a method for facilitating the creation of media. At block 162, a submission of a proposal by an artist initiates the process which continues to block 163, wherein a pledge period begins that provides an opportunity to consumers to pledge money to the proposal. In this implementation, a request is not necessary to start the process. As depicted by blocks 164 and 165, at least partially simultaneously with the pledge period, an artist's accept/reject period begins wherein the artist is presented with an opportunity to accept the existing pledges, thereby commissioning the creation of the media and creating a contract for creation of the same with the consumers that pledged money. The pledged money forming a portion of the commission. As illustrated by block 164, the pledge period and artist accept/reject period overlap. In one implementation, once a certain threshold of pledges have been made, the artist is given an opportunity to accept the pledges in exchange for creating the media. The threshold may be a number of pledges, which may be as low as one, or an aggregate amount of pledged dollars. Continuing with the description of the particular implementation, once the pledge period expires and the pledges are firm then the artist must accept or reject the pledged money.

At block 166, a work period beings wherein the artist is provided with time to complete the commissioned media. In an alternate embodiment, consumers may pledge money during the work period. This is particularly relevant if the media will not be mass distributed or widely available and a consumer desires to obtain the media once it is created. At block 167, the created media is subject to a review process prior to being released at block 168 during a release period. Any overlap scheme, such as that presented with respect to the pledge period and artist accept/rejected period, may be also employed. Further, it should be appreciated that any number of stages or periods or any amount of compression may be utilized with the teachings presented herein. By way of example, FIG. 7B presents a decompressed version of the methodology presented in FIG. 7A.

Prior to presenting FIG. 7B, however, a decompressed version of blocks 162 through 165 will be presented that illustrate a computer-assisted method of facilitating digital media creation. Blocks 162 through 165, an artist proposing to create the digital media and a plurality of consumers are connected through a computer network to provide for a collective negotiation therebetween. A proposal from the artist that describes terms of creation of the digital media and specifies characteristics of the digital media is provided and presented from the artist to the plurality of consumers (block 162). There is then an opportunity for a subset of the plurality of consumers to pledge money to the proposal (block 163). During this period, a plurality of pledges of non-uniform amounts from the plurality of consumers are accepted. By way of example, the non-uniform amounts may include amount $X and amount $Y, where X is different from Y. It should be appreciated that in one implementation the subset of the plurality of consumers may map to any set of non-uniform amounts having more than one amount. Once the pledge period closes, the artist is permitted to make an accept/reject selection in response to the pledged money from the subset of the plurality of consumers (block 165).

In response to the accept/reject selection comprising accept, the instance of digital media may be commissioned, the pledged money from the subset of the plurality of consumers may be placed in trust or escrow pending the completion of the commissioned instance of digital media, and the artist is compensated with the pledged money following the creation of the instance of digital media. On the other hand, in response to the accept/reject selection comprising reject, the proposal is withdrawn and the pledged money is returned to the subset of the plurality of consumers.

FIG. 7B depicts a flow chart depicting a further embodiment of a method for facilitating the creation of media. The method, as illustrated, includes nine stages. It should be appreciated, as previously discussed, that the methodology presented herein may include any number of stages. At block 170, the pre-request period defines the period before a request has been initiated and it is during this period that requests are created. At block 172, the proposal submission period defines the stage wherein artists submit proposals in response to requests. Additionally, artists may submit proposals on their own as well. This period begins when a consumer makes a request and expires when a proposal is received or a request deadline is reached. During this period, consumers may pledge money to a request or tie money to a request with the intent of pledging the money tied to the request to a corresponding proposal, upon receipt of the proposal.

Once an artist makes a proposal, the pledge period begins at block 174 wherein, in some implementations, an artist additionally has an opportunity to refine the proposal based on consumer feedback and consumer pledges. Typically, however, this is the stage where consumers are given an opportunity to pledge or modify existing pledges. The stage ends when a pledge deadline is reached. At block 176, the first pledge decision period is reached and consumers are able to see an unchangeable proposal and make a final decision about if and how much to pledge. At the end of this pledge decision period, the consumers' pledges are firm and the consumers are not able to withdraw or otherwise modify their respective pledges.

At block 178, during the artist decision period, i.e., the second pledge decision period, an artist is able to see how much pledge money is firmly placed on a proposal and, accordingly, decide whether or not to accept or reject a commission for creating the media. This period begins when the pledge deadline is reached and ends when the artist accepts or rejects or when an acceptance deadline is reached. At block 180, the work period begins, which is the time when the artist that accepted the commission works to create the media and updates consumers who have pledged on the progress. This stage occurs when the artist accepts the commission and ends when the artist submits media, cancels the commission, or the completion deadline is reached with no artist submission. During the work period, the artist may periodically upload media samples or the like for review by the consumers that pledged.

At block 182, during the verification period, the marketplace engine verifies that the media meets the stipulations of the commission contract. This stage is initiated when the artist submits the media and ends after a pre-specified period of time such as two days. In one implementation, at block 184, a commentary period, which may include complaints, follows the verification period and defines a pre-specified period of time during which consumers that pledged money to the creation of the media verify that the process is complete. At block 186, the final stage is the release period wherein the media is freely available for public trade in accordance with any terms, controls, and conditions on the creation and distribution. Additionally, at this time, the artist is paid.

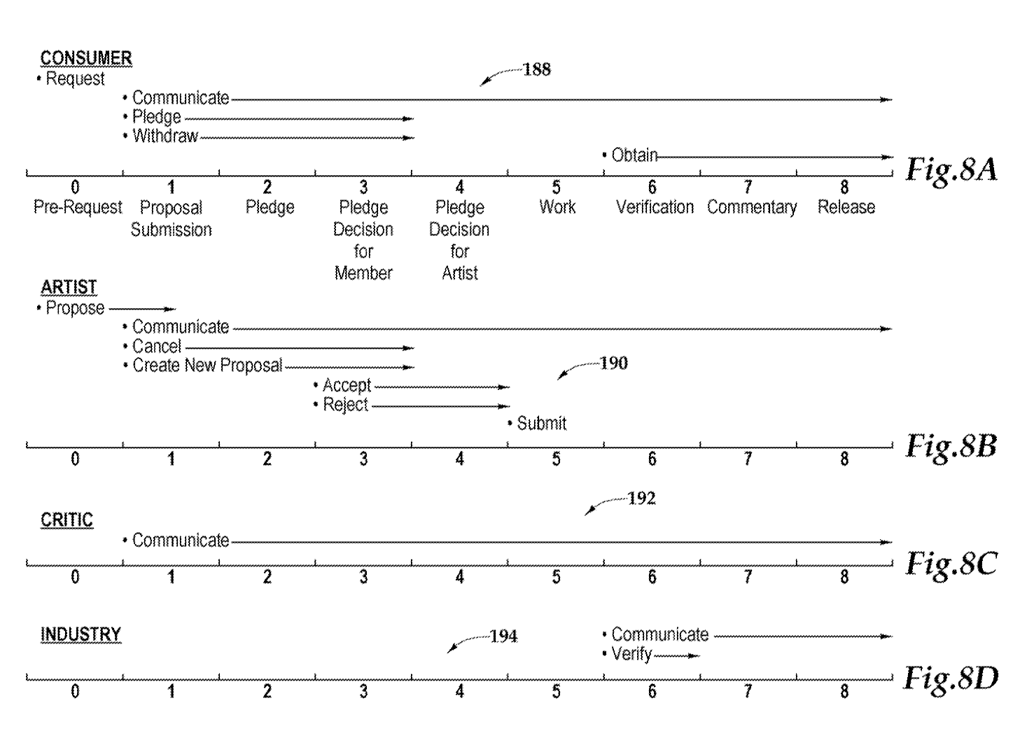

FIG. 8A depicts a time line of one embodiment of the stages 188 that a consumer encounters during the creation of the media. As previously discussed, the systems and methods presented herein facilitate a collective bargaining process between groups of consumers and an artist by engaging the consumers and the artist in a negotiating process wherein the rights of each group are progressively limited, restricted, or reduced. By defining a plurality of stages and progressively limiting the rights of the one or more consumers and the artist, the parties are able to reach an agreement to the terms of the commissioning of an instance of media.

In the illustrated implementation, the process is divided into nine periods or stages; of which, the first five stages represent the collective bargaining process and the final four stages represent the commissioning and distribution of the media. It should be appreciated, however, that the teachings presented herein provide for any number of stages in total and any number of stages in each of the bargaining process and commissioning/distribution of the media.

At a first stage, which is indicated as the Pre-request Period 0, the consumer may make a request, which as previously discussed, provides specifications for an instance of media. Once a request is made, the process is initiated and continues to stage 1, which is the Proposal Submission Period 1. During this stage, the consumer may communicate with other consumers and artists as well as review pledges which are made in response to the consumer's request. If the consumer is satisfied with a particular proposal, then the consumer may pledge money to the proposal and, likewise, increase or decease the amount of the pledge as well as withdraw the pledged money entirely.

The Pledge Period 2 may be reached by two general types of consumers. The consumer which initiated the request during the Pre-request Period 0, upon initiating the request, enters the Proposal Submission Period 1. Additionally, consumers which are browsing and searching the proposals made by artists may enter the bargaining process of the Pledge Period 2. During the Pledge Period 2, similar to the Proposal Submission Period 1, the consumers may pledge money and either modify or withdraw their pledges.

The Pledge Decision Period 3 provides the consumers with the last opportunity to pledge money, modify pledges, or withdraw pledges. As previously discussed, the consumers may pledge varying or non-uniform amounts that correspond to the interest and wherewithal of each, for example. Pledges are firm at the end of the period wherein the Pledge Artist Decision Period 4 and the Work Period 5 occur. During both these periods, the consumers can only communicate. In one embodiment, the consumers may obtain the media beginning in Verification Period 6 so that the consumers can ensure that the media conforms with the proposal. Additionally, in Verification Period 6 and continuing with Commentary Period 7 and Release Period 8, the consumers can communicate and give commentary.

FIG. 8B depicts a time line of one embodiment of the stages 190 an artist encounters during the creation of the media. The artist begins activity at the Proposal Submission Period 1 by either submitting a proposal in response to a request or submitting an independent proposal. In addition to initiating a proposal, during the Proposal Submission Period 1, the artist may communicate, cancel a proposal, or based on commentary received from the community, create a new proposal. In one implementation, the artist's actions or rights remain the same during the Pledge Period 2 and Pledge Decision Period 3. At the end of the Pledge Decision Period 3, once the pledges of the consumers are firm, the artist has the option of accepting or rejecting the pledges tied to the proposal to create a commission for the instance of media. In an alternate embodiment, the artist may accept or reject the pledges tied to the proposal in Period 3, the Pledge Decision Period for the Consumer.

If the artist accepts the proposal and a commission is formed, then the process advances to the Work Period 5, otherwise, if rejected, the process returns to the Pre-Request Period 0. In the Work Period 5, the artist may submit the digital media to the marketplace engine once the digital media is complete. If the media is not digital, however, then the artist may submit a proxy, such as a photograph, for example, indicating that the non-digital media was ready. By way of further example, the media may be an event such as a concert or type of exhibition and the proxy may be a ticket. Additionally, during the Work Period 5, the artist may initiate communications and also submit samples of the media in progress to receive further feedback from the consumers. Once the work is submitted, the artist only communicates during the Verification Period 6, Commentary Period 7, and Release Period 8.

FIG. 8C depicts a time line of one embodiment of the stages 192 a critic encounters during the creation of the media. Once the Proposal Submission 1 begins and therethrough the entire process, the critic may only communicate commentary. It should be appreciated that the critic may be a professional or recognized critic, as well as, for example, a consumer not interested in pledging and only interested in providing commentary.

FIG. 8D depicts a time line of one embodiment of the stages 194 the industry encounters during the creation of the media. The industry takes no action until Proposal Submission Period 6 when, in one implementation, the industry is given the opportunity to review the media prior to the general release of the media to verify that the creation of the media does not involve any misappropriation of intellectual property rights of others such as copyrights.

With reference to FIGS. 8A through 8D and, in particular, FIGS. 8A and 8B, the systems and methods presented herein provide bargaining services to the one or more consumers and the artist whereby the one or more consumers and the artist agree to the terms of the creation of the instance of the media. The bargaining process is defined by a plurality of stages wherein the rights of the one or more consumers and the artist are progressively limited. As discussed, the consumers may make pledges and modify or withdraw their respective pledges. As the stages of the bargaining process advance, however, the right of the consumers to withdraw their pledges is lost and the pledges are firmed. Correspondingly, the artist must either accept or reject the pledged money. This progressive limitation of the rights of the consumers and the artist facilitates the parties agreeing to terms of the creation of the instance of the media as specified in the proposal.

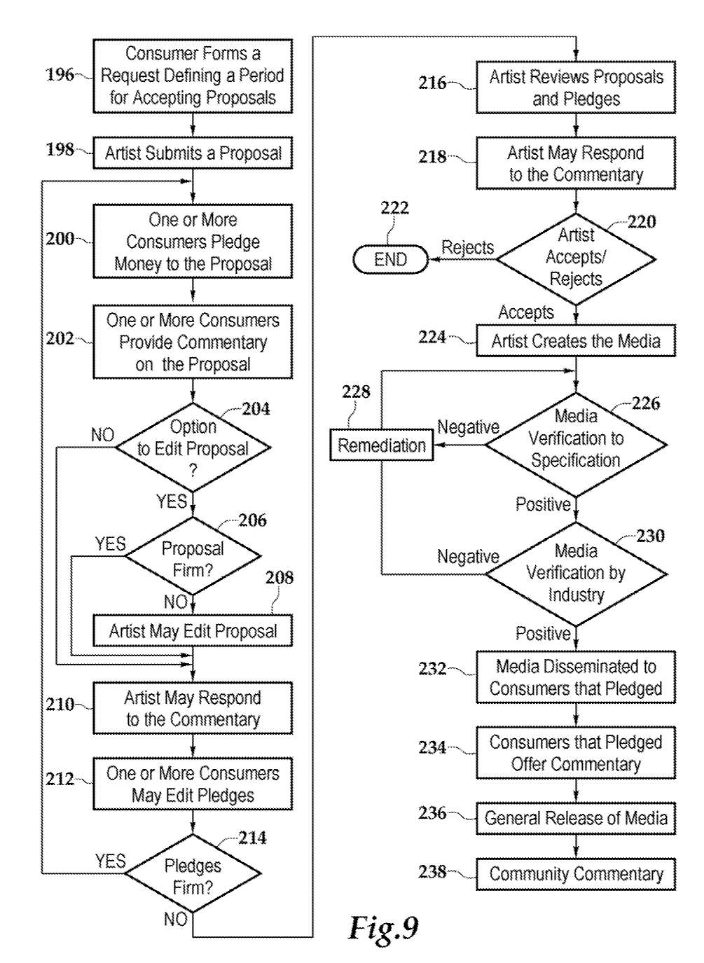

FIG. 9 depicts another embodiment of a method for facilitating media creation. At block 196, a consumer forms a request defining a period for accepting proposals from artists. It should be appreciated that in an alternative embodiment, the marketplace engine defines the period for accepting proposals. At this time, the marketplace engine catalogs and indexes the proposal to make it searchable and accessible to the marketplace community including artists. At block 198, an artist submits a proposal in response to the request. Similar to the request, the proposal is cataloged and indexed so that the marketplace community may access it.

At block 200, upon reviewing the proposal, one or more consumers tie pledges of money, which may be pledges of non-uniform amounts of money, to the proposal. Additionally, at block 202, the one or more consumers may provide commentary on the proposal. Block 204 represents two possible embodiments in the methodology. If the artist has the option to edit the proposal, then the methodology advances to decision block 206 wherein the artist is provided with an opportunity to modify the proposal in response to the commentary provided by consumers as discussed in block 206. Otherwise, block 210 is the next step.

At decision block 206, if the proposal is not yet firm, then the process advances to block 208 where the artist may edit the proposal in response to the pledges of money and commentary received form the marketplace community. After block 208 or if the proposal is firm, the process advances to block 210 where the artist may respond to the commentary and engage in a discussion with the marketplace community about the proposal and associated instance of media that may be created.

The one or more consumers may edit or modify the pledges at block 212. For example, the pledges may be increased or decreased in value or entirely withdrawn. At decision block 214, if the pledges may still be edited or modified, then the process returns to block 200 and the methodology described in blocks 200 through 214 is repeated. Once the time period for editing pledges has expired, then the process advances to block 216 where the artist makes a final review of the proposals and pledges. As part of the review process, at block 218, the artist may respond to any commentary.

At decision block 220, the artist rejects or accepts the proposal based on the pledges of money tied to it. If the artist rejects the proposal then the process ends, as indicated by block 222. On the other hand, if the artist accepts the proposal and associated pledges of money, then the instance of media is commissioned and at block 224, the artist creates the instance of media.

Once the instance of media is created, the media is verified with respect to the proposal at block 226. If the verification is negative then, depending on the conditions of the proposal and pledges of money, the artist may be given an opportunity to remedy the defects in the instance of media at block 228. Once the instance of media is remedied, then the revised instance of media is re-verified at block 226. Upon a positive review of the instance of media, the process advances to block 230, where the industry may verify that the media does not infringe any existing intellectual property rights. If the review is negative, then the artist may be presented with an opportunity to remedy any concerns of the industry at block 228. Otherwise, upon a positive review, the process advances.

At block 232, the media is disseminated to the consumers that pledged money and entered into a commission of the media. At block 234, the consumers may offer commentary of the instance of media. At block 236, if in accordance with the terms of the creation of the media and any licensing and associated distribution schemes, the media is generally released and, at block 238, the entire community including consumers, critics, and the industry, may provide review, commentary, and critique of the media.

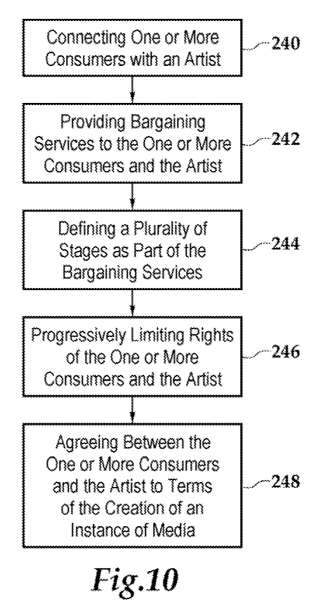

FIG. 10 depicts a further embodiment of a method for facilitating media creation. At block 240, one or more consumers are connected with an artist. The one or more consumers and the artist share a common interest in creation of an instance of media. At block 242, the marketplace engine discussed herein provides bargaining services to the one or more consumers and the artist. The marketplace engine defines a plurality of stages as part of the bargaining services at block 244. In each of the stages that the one or more consumers and the artist encounter, the rights of either or both of the one or more consumers and the artist are progressively limited as shown in block 246. At block 248, as the result of the progressively limited rights of the parties, the parties reach an agreement as to the terms of the creation of the instance of the media. It should be appreciated that the methodology of FIG. 10, as well as the other figures, may be expressed as instructions on a computer-readable medium or electromagnetic signals traversing a computer network.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for facilitating media creation operating in a networked environment, the system comprising:
a marketplace module that connects a plurality of consumers with an artist in a collective negotiation, the plurality of consumers and the artist having a common interest in creation of an instance of media;
a plurality of stages, each of the plurality of stages providing a progressively limiting set of rights to the one or more consumers and the artist;
a plurality of pledges of non-uniform amounts from the plurality of consumers, the plurality of pledges of non-uniform amounts forming a commission between the plurality of consumers and the artist upon an agreement to the terms of the creation of the instance of media; and
a facilitator associated with the marketplace module, the facilitator providing bargaining services to the plurality of consumers and the artist whereby the plurality of consumers and the artist are advanced through the plurality of stages in order to reach the agreement to the terms of the creation of the instance of the media.

2. The system as recited in claim 1, wherein the marketplace module connects the plurality of consumers and the artist by providing for an exchange of specifications that describe the instance of the media.

3. The system as recited in claim 1, wherein the plurality of consumers may dynamically change during the facilitation and agreement of the terms of the creation of the instance of the media.

4. The system as recited in claim 1, wherein the marketplace module and the facilitator are at least partially integrated together.

5. A method for facilitating media creation, the method comprising:
connecting a plurality of consumers with an artist, the plurality of consumers and the artist having a common interest in creation of an instance of media;
providing bargaining services to the plurality of consumers and the artist to provide for a collective negotiation therebetween;
defining a plurality of stages as part of the bargaining services;
progressively limiting rights of the plurality of consumers and the artist as the bargaining services progress through the plurality of stages;
accepting a plurality of pledges of non-uniform amounts from the plurality of consumers;
agreeing between the plurality of consumers and the artist to terms of the creation of the instance of the media; and
utilizing the plurality of pledges as a commission for the instance of the media.

6. The method as recited in claim 5, further comprising exchanging specifications between the plurality of consumers and the artist, the specifications describing the instance of the media.

7. The method as recited in claim 5, wherein defining the plurality of stages as part of the bargaining services further comprises selecting stages from a group consisting of a pre-request period, proposal submission period, pledge period, pledge decision period, artist decision period, work period, verification period, commentary period, and release period.

8. At least one computer-readable medium comprising instructions and data written thereon, the instructions and the data containing information for practice of the method as recited in claim 5.

9. Electromagnetic signals traveling over the computer network, the electromagnetic signals comprising information for practice of the method as recited in claim 5.

10. A computer-assisted method of facilitating digital media creation, the method comprising:
connecting an artist proposing to create the digital media and a plurality of consumers through a computer network to provide for a collective negotiation therebetween;
receiving a proposal from the artist that describes terms of creation of the digital media and specifies characteristics of the digital media;
presenting the proposal from the artist to the plurality of consumers;
providing an opportunity for a subset of the plurality of consumers to pledge money to the proposal;
accepting a plurality of pledges of non-uniform amounts from the plurality of consumers;
permitting the artist to make an accept/reject selection in response to the pledged money from the subset of the plurality of consumers;
in response to the accept/reject selection comprising accept, performing the following:
(i) commissioning the instance of digital media,
(ii) placing the pledged money from the subset of the plurality of consumers in trust, and
(ii) compensating the artist with the pledged money following the creation of the instance of digital media; and
in response to the accept/reject selection comprising reject, withdrawing the proposal and returning the pledged money to the subset of the plurality of consumers.
